(19) United States
(12) Patent Application Publication
(10) Pub. No.: US 2005/0156577 A1
(43) Pub. Date: Jul. 21, 2005

(54) Method for charge control for extending Li-Ion battery life

(76) Inventor: Henry Sully, Suwanee, GA (US)

Correspondence Address: ARRIS INTERNATIONAL, INC, 3871 LAKEFIELD DRIVE, SUWANEE, GA, 30024, US

(21) Appl. No.: 11/039,098

(22) Filed: Jan. 20, 2005

Related U.S. Application Data
(60) Provisional application No. 60/538,036, filed on Jan. 21, 2004.

(51) Int. Cl. H02J 7/00

(52) U.S. Cl. 320/160

(57) ABSTRACT

An algorithm extends the serviceable life of a Li Ion battery by charging a battery to a predetermined percentage of its rated charge capacity. The amount of energy impressed into the battery during charging is determined by periodically measuring the charge energy impressed at a given instance, and integrating the instantaneous energy measurements with respect to time over the charging period. Each time the battery is subsequently recharged, charging the battery to this same amount of energy provides the same amount of energy during discharge. Upon each subsequent recharge following the initial charge, the battery terminal voltage is slightly higher than at the end of the previous recharge. When the terminal voltage measured before the end of a recharge period exceeds the battery's rated voltage, the algorithm ends and indicates that the battery can no longer be used in the given application and should be replaced.

### CROSS REFERENCE TO RELATED APPLICATION

This application priority under 35 U.S.C. 119(e) to Sully, U.S. provisional patent application No. 60/538,036 entitled “Extending Li-ion battery life with a charge control algorithm,” which was filed Jan. 21, 2004, and is incorporated herein by reference in its entirety.

### FIELD OF THE INVENTION

The present invention relates generally to communication devices, and more particularly to maintaining the service life of a rechargeable energy source.

### BACKGROUND

Conventional telephony systems have been around for more than a century. The familiar ‘land line’ telephone system is a reliable and trusted way to communicate voice traffic with others, as well as to transport digital signals. In addition to traditional telephony, many communication devices, such as, for example, wireless phones, cable modems and others, may facilitate the providing of telephony and other communication services, such as internet traffic, video, music and other multimedia traffic. It is desirable, and can be critical in an emergency situation, that these devices operate reliably without failure.

However, unlike traditional telephony which is powered by current carried in the communication lines that connect communication devices to a central office, the power supply for these newer device families is typically based on AC household current that is transformed into a DC current at a lower voltage. Since household current is more prone to outages than the power supplied through a traditional telephone connection, a backup energy source is normally used that automatically supplies power to the communication device upon loss of offsite power (“LOOP”).

The energy from these backup supplies is typically provided by a rechargeable battery system. Lithium Ion (“Li-Ion”) batteries are often used, as they have a relatively high charge density as compared with other battery types. As is typical with rechargeable batteries, Li-Ion batteries take a finite time to become charged and to recharge, and have a service life that is inversely proportional to the number of cycles of charging and discharging the battery undergoes. In other words, the more times a battery is recharged, the less charge it can store upon each successive recharge. However, a battery that is maintained at its full charge capacity for long periods of time will lose its recoverable capacity at an even higher rate.

Once a battery has degraded to the point where it can no longer provide the required minimum energy following a full recharge, it should be replaced. Since the cost of Li-Ion batteries is high compared to other batteries, there is a need for a method and system for maintaining a Li-Ion battery at a charge that can provide automatic backup upon a LOOP, while extending the service life of a battery.

### SUMMARY

By placing a battery into service at a minimal charge level to provide the required minimum energy of the communication device, the average applied voltage to the battery is minimized and the rate of degradation of recoverable capacity is greatly reduced, thereby extending the replacement interval. The selected battery is selected so that its initial capacity exceeds minimum backup energy required by the communication device.

To accomplish this end, an adaptive battery charging algorithm is used to maintain battery charge and/or restore depleted charge to the minimum amount of energy that is required to maintain the minimum backup energy required by the communication system. This system of charging is independent of battery capacity, as long as there is sufficient capacity available, i.e., the battery has more capacity than the minimum backup energy required by the communication device. The charging algorithm resets the battery to the required minimum energy by discharging it to its cutoff voltage, and then recharging the battery while monitoring the instantaneously applied energy and the elapsed time. When the required minimum total energy has been delivered to the battery, the charging is terminated. As this process is repeated, the battery voltage at the end of each charge cycle will gradually increase due to degradation of recoverable capacity until the battery will no longer accept the required energy without exceeding its maximum voltage rating. However, by limiting the amount of energy delivered to the battery at each recharge interval, the battery is able to maintain the minimum energy required by the communication system for a much longer period as compared previous methods because the average charge voltage applied to the battery is greatly reduced when integrating it over its entire service life.

### BRIEF DESCRIPTION OF THE DRAWINGS

FIG. 1 illustrates a conventional method for charging a Li Ion battery.

FIG. 2 illustrates a method for charging a Li Ion battery that minimizes degradation of the battery's service life.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

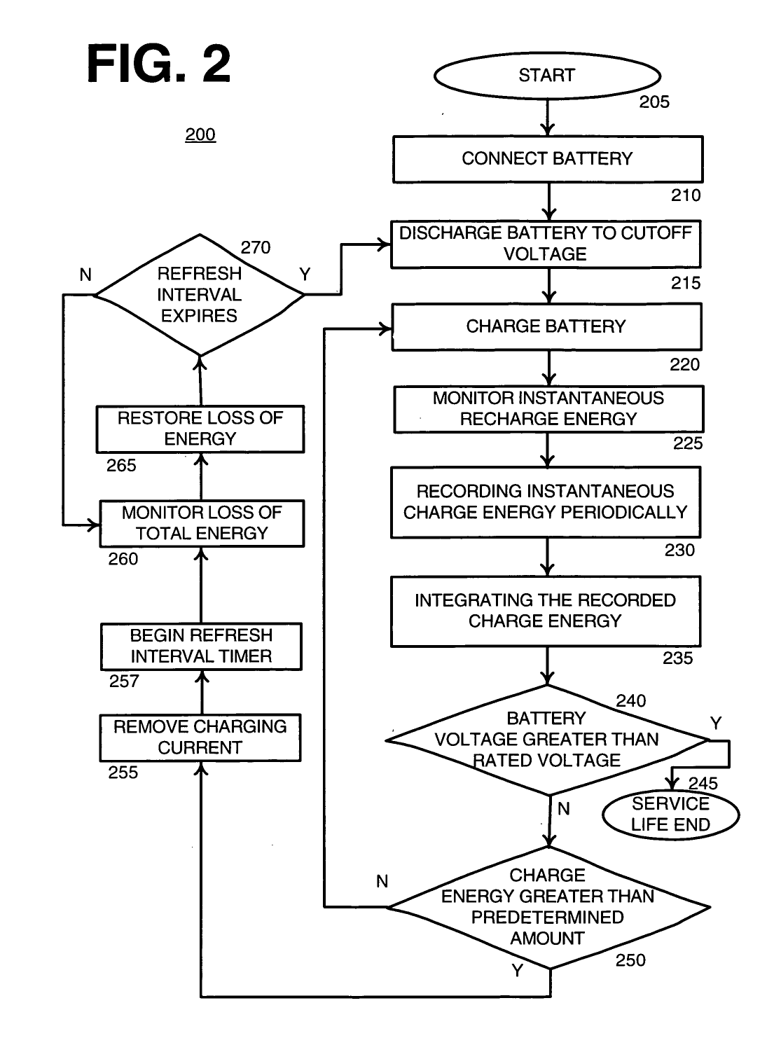

Battery charging devices are known in the art, and typically include a connecting means, such as cables connected to spring loaded jaws, as in chargers for automobile batteries, or metallic interfacing strips, that connect the batteries to be charged to charger circuitry. The charger circuitry may include a simple transformer that transforms AC current to DC current, and an electronic means for regulating and changing the waveform of the charging current. A voltage regulator circuit is also typically included to prevent overcharging. Charging for batteries that are sensitive, such as NiCd and Li-Ion, for example, may use microprocessor circuitry to control the charging waveform, to measure various parameters related thereto, such as, for example, current and voltage waveforms, charging time, and instantaneous current and voltage magnitudes, to store these measured values onto a medium such as a computer memory, or other similar device, and to calculate values, such as power, charge amount, estimated time until charged, etc. The microprocessor typically executes an algorithm for controlling the charging current waveform and for controlling the measuring and storing to a memory device of the various data that is acquired by the charging device. Thus, the microprocessor of a conventional charging device may be programmed to implement an algorithm known in the art for charging a battery, as well as the algorithm disclosed below in reference to FIG. 2. Thus, a diagram of the basic components that compose a battery charger need not be provided in the figures.

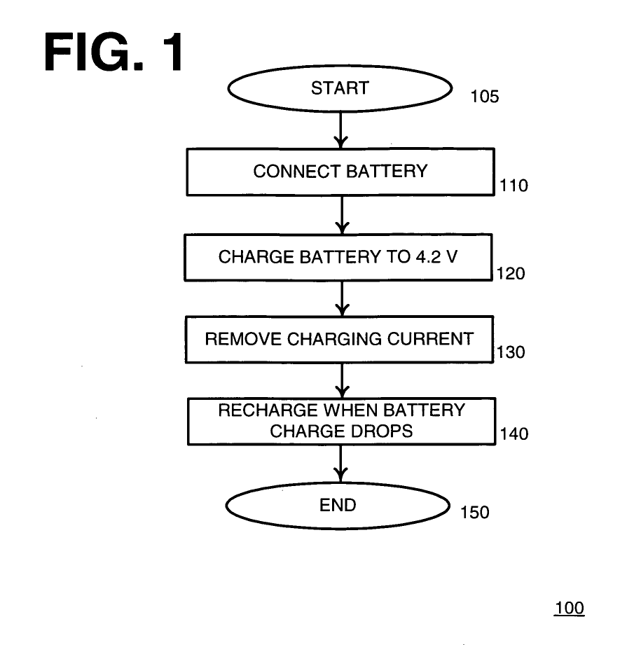

Turning now to the figures, FIG. 1 illustrates an example using a conventional approach to charging a Lithium-Ion battery, using a defined system requirement for energy with a defined battery specification. The defined system backup energy requirement is four watt-hours. The defined battery is rated for 8.25 watt-hours at 4.2 volts maximum charge voltage. The rate of degradation of recoverable capacity is 15% per year when charged to its maximum rated voltage and decreases to 1% per year when charged to a lower voltage that corresponds to 50% of its rated capacity. It will be appreciated that the relationship between the amount of charge stored in a battery and the terminal voltage is typically not linear. Thus, for a Li Ion battery having terminal voltage of 4.2 V when it stores its maximum rated charge, its terminal voltage may not be 2.1 V when storing half of its rated charge.

The battery is placed into the system at step 110. At step 120, the charger provides a maximum energy charge to the battery by charging it to a maximum rated charge voltage, typically 4.2V. Once charged, the charging current is removed at step 130. After the charging current has been removed, the battery will slowly self-discharge. In addition, the system being powered by the battery may require some or all of the stored energy of the battery. At step 140, the charger may restore the lost energy by periodically checking the stored charge energy and recharging the battery as needed to the rated battery charge terminal voltage.

As the battery ages, the recoverable capacity of the battery diminishes at the rate of approximately 15% per year, since it is maintained at full rated charge. After 4 to 5 years, the battery typically will no longer provide the system with the required minimum energy of four watt-hours due to the rapid loss of recoverable capacity and should be replaced.

Turning now to FIG. 2, a second example is illustrated that uses charging method 200 for extending battery service life using the same defined system requirement and battery performance described in the example illustrated in FIG. 1. The method starts at step 205 and the battery is placed into the system at step 210. The charging device fully discharges the battery to its cutoff voltage at step 215 and then begins charging the battery at step 220 by impressing a charge current into the battery. It will be appreciated that for Li-Ion batteries, a constant charge current is desired. Variable charge current may be desired for certain applications, such as for example, if the batteries being charged are not Li-Ion batteries. While the battery is charging, the instantaneous charge energy is monitored and measured at step 225. The measured charge energy is recorded at step 230.

The currently recorded charge energy measurement and the instantaneous charge energy measurements recorded during previous iterations of the method are integrated at step 235 over the charging period, which begins at the first iteration of step 220. The result of this integration is the cumulative charge energy impressed into the battery by the charger device. As discussed above, merely measuring the terminal voltage does not provide an accurate determination of the charge impressed into the battery because voltage and charge energy do not correspond linearly with one another, as discussed above in reference to FIG. 1 Thus, the total, or cumulative, charge provided to the battery during a charge cycle can be determined based on the integration of instantaneous charge energy measurements, where each measurement is acquired periodically by the charging device at each iteration of the method during the charging period.

As the battery is charging, the battery-charging device also monitors the battery voltage at step 240 and removes the charging current at step 245 if the voltage exceeds the rating of 4.2V—this is the typical rated terminal voltage for Li-Ion, but this value can vary depending on the application—while charging. When the terminal voltage reaches and exceeds the rated terminal voltage, the battery's service life has ended, and should be replaced. The charging device can display a message, or indication, such as, for example, illuminating a red LED, warning that the battery should be replaced.

If the terminal voltage does not exceed the battery's rated voltage, the battery-charging device determines at step 250 whether the total charge energy determined at step 235 exceeds a predetermined amount—in the illustrated case, the predetermined amount is four watt-hours. When the cumulative (re)charge energy (as determined by integrating the instantaneous charge energy measurement) reaches the predetermined amount, the charge current is removed at step 255 and the battery voltage is recorded into the charging device's memory. If at step 250 the total charge energy impressed into the battery during charging does not exceed the predetermined amount, the charging device continues charging and begins another charging iteration at step 220. A refresh interval/period timer starts at step 257.

Once charged, and after the charging current has been removed, the battery will slowly self-discharge. In addition, the system being backed-up by the battery may require some or all of the backup energy. The charger may restore the lost energy by measuring at step 260 battery terminal voltage and/or discharge energy. When, for example, the amount of discharge energy or the terminal voltage drops below a predetermined threshold, the lost charge is restored to the battery at step 265; The amount of lost charge may be determined by an integration of periodic discharge current measurements over time until the integral result equals a predetermined amount. The lost charge may be restored by impressing a charging current into the battery for an amount of time such that the total charge restored equals the amount of charge lost. Alternatively, the terminal voltage may be periodically measured and when it drops below a predetermined threshold, charge current can be impressed into the battery until the terminal voltage equals the voltage determined at step 240.

If the refresh period that began at step 257 has not expired at step 270, discharge energy (or terminal voltage, for example) continues to be monitored at step 260 and replaced at step 265. When the refresh period expires at step 270, the battery is discharged again at step 215, and the charging procedure begins as described above. For example, the refresh period may be set to six months, so that a full discharge and recharge occurs twice per year. It will be appreciated that other refresh intervals may be selected. During the refresh interval/period, the discharge is measured and lost energy is restored at step 265.

As the battery ages, the recoverable capacity of the battery diminishes at the rate of 1% per year, since it is being charged to a voltage that is less than its rated capacity. A predetermined charge amount of approximately 50% of its battery's rated capacity is preferably selected for the first, and early, recharge cycles. Regardless of the initial predetermined percent of capacity charge amount, the battery should be sized such that this amount is sufficient to provide at least the minimum required energy of the device being power by the battery. This contrasts with conventional charging methods that typically charge to the full capacity based on terminal voltage as with conventional charging methods.

Each time the battery is charged to the predetermined charge energy (four watt-hours in the example scenario) following discharge at step 215, the battery charge termination voltage will increase slightly due to the loss of recoverable capacity. In turn, the rate of degradation of recoverable capacity will also increase. When the required predetermined charge energy has not been attained but the maximum charge voltage has been reached at step 240, the battery has reached the end of its useful life and should be replaced. Because the charging method 200 maintains battery energy at a level that is lower than the battery's rating for the majority of its service life, the average rate of degradation of recoverable capacity is minimized, thus extending its useful life beyond what it would be using conventional charging methods.

Graph 1 below compares service life for the two scenarios just described. A linear method is used to calculate the rate of degradation of recoverable capacity for a particular ratio of applied charge to recovered capacity, which varies at each recharge interval over a range of 0.5 to 1.0 from beginning to end of service for the example described in reference to FIG. 2. For the example given in reference to FIG. 1, the ratio is 1.0 for each recharge discharge cycle. A one-year discharge/recharge interval is assumed for both examples. Thus, when a battery is sized for a given device so that the maximum charge needed to meet a device's energy needs is provided when the battery is charged to about 50% of its when-new maximum capacity, the serviceable life of the battery is extended as compared to the scenario where the battery is charged to 100% of its charge capacity every time it is recharged.

[image]

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents. It will be appreciated that in the example scenario illustrated in reference to FIG. 2, the percentage of charge to which a battery is initially charged on a first, or early, charge-discharge cycle, was selected as 50% of the battery's total charge capacity when new, i.e., the battery has not degraded due to charge-discharge cycles. However, although this may be a desirable charge percentage to use for sizing a battery for many applications, this percentage was selected for purposes of illustration and is not meant to limit the predetermined amount of charge capacity at which method 200 removes charging current at step 245.

1. A method for charging a battery with a charger device, comprising:
fully discharging the battery using the charger device;
applying a charging current to the battery with the charger device to charge the battery;
measuring the instantaneous charge energy as the battery charges;
recording the instantaneous charge energy periodically;
determining a cumulative total charge energy by integrating the recorded instantaneous charge energy with respect to time; and
removing the charging current when the total cumulative charge energy reaches a predetermined amount.

2. The method of claim 1 further comprising:
measuring the instantaneous discharge energy as the battery discharges during a predetermined refresh interval;
recording the instantaneous discharge energy periodically during the refresh interval;
determining a cumulative total discharge energy; and
charging the battery with the cumulative total discharge energy amount.

3. The method of claim 1 wherein the steps are repeated after a refresh interval has elapsed.

4. The method of claim 2 wherein the cumulative total discharge energy is determined by measuring the battery's terminal voltage and approximating the discharge current based on this measured voltage.

5. The method of claim 1 wherein the cumulative total discharge energy is determined by integrating the recorded instantaneous discharge energy with respect to time over the discharge interval.

6. The method of claim 1 wherein the predetermined charge energy amount is equal to the minimum energy amount requirement of the system for which the battery is to provide energy.

7. The method of claim 1 wherein the predetermined charge energy amount is equal to the minimum energy amount requirement of the system for which the battery is to provide energy and wherein the battery terminal voltage at the end of a charging cycle is less than or equal to a predetermined maximum amount.

8. The method of claim 7 wherein the battery terminal voltage at the end of each successive charging cycle is progressively increased over the life of the battery.

9. The method of claim 1 wherein the battery's end of service life is indicated when, during a charge cycle, the battery's rated terminal voltage is reached before the charge energy reaches the predetermined amount.

10. A method for charging a battery, comprising:
measuring the charge energy as the battery charges at periodic intervals during a charging period;
recording the charge energy amount for each periodic charge energy measurement;
determining a cumulative charge energy during the charging period by integrating the recorded charge energy amounts for each charge energy measurement with respect to time over the charging period;
removing charging current from the battery when the cumulative charge energy reaches a predetermined amount;
measuring the instantaneous discharge energy as the battery discharges during a predetermined refresh interval;
recording the instantaneous discharge energy periodically during the refresh interval;
determining a cumulative total discharge energy; and
charging the battery with the cumulative total energy discharged during the refresh interval.

11. The method of claim 10 wherein the steps are repeated after the refresh interval has elapsed.

12. The method of claim 10 wherein the instantaneous discharge energy is measured by measuring the battery's terminal voltage and the cumulative total discharge energy is determined by approximating the discharge current based on this measured voltage.

13. The method of claim 10 wherein the cumulative total discharge energy is determined by integrating the recorded instantaneous discharge energy with respect to time over the discharge interval.

14. The method of claim 10 wherein the predetermined charge energy amount is equal to the minimum energy amount requirement of the system for which the battery is to provide energy.

15. The method of claim 10 wherein the predetermined charge energy amount is equal to the minimum energy amount requirement of the system for which the battery is to provide energy and wherein the battery terminal voltage is less than or equal to a predetermined maximum amount.

16. A system for charging a battery, comprising:
means for discharging the battery;
means for impressing charge into the battery;
means for measuring the instantaneous charge or discharge energy as the battery charges or discharges;
means for recording the measured instantaneous charge or discharge energy periodically;
means for determining a cumulative total charge or discharge energy by integrating the recorded instantaneous charge or discharge energy measurements with respect to time over a predetermined period; and
means for removing the charging current when the total cumulative recharge energy reaches a predetermined amount.

17. The method of claim 16 wherein an initial predetermined recharge energy amount is 50% of the battery's rated energy capacity.

18. The method of claim 16 wherein the battery is a lithium ion battery.

19. The method of claim 16 wherein the predetermined charge energy amount is equal to the minimum energy amount requirement of the system for which the battery is to provide energy.

20. The method of claim 16 wherein the predetermined charge energy amount is equal to the minimum energy amount requirement of the system for which the battery is to provide energy and wherein the battery terminal voltage is less than or equal to a predetermined maximum amount.

21. The system of claim 16 further comprising a means for charging the battery with an energy amount equal to an amount discharged during a refresh interval.
